(19) United States
(12) Patent Application Publication
(10) Pub. No.: US 2026/0228361 A1
(43) Pub. Date: Aug. 6, 2026

(54) MOBILE DEVICE WITH CONFIDENTIAL MATERIAL DETECTION

(71) Applicant: Motorola Mobility LLC, Chicago, IL (US)

(72) Inventors: Ranjeet Gupta, Aurora, IL (US); Rahul Bharat Desai, Hoffman Estates, IL (US); Andrew Wheeler, Arlington Heights, IL (US)

(73) Assignee: Motorola Mobility LLC, Chicago, IL (US)

(21) Appl. No.: 19/043,219

(22) Filed: Jan. 31, 2025

(51) Int. Cl. G06F 21/62; G06F 3/14; G06T 7/10

(52) U.S. Cl. CPC G06F 21/6254; G06F 3/14; G06T 7/10; G06T 2207/20081; G06T 2207/20084

(57) ABSTRACT

In aspects of controlling imaging of confidential material, a mobile device implements a confidential material detection system that is employed to acquire preview image data and process the preview image data using at least one machine-learning model. The at least one machine-learning model is trained to identify confidential material in the preview image data. Responsive to detection of confidential material, the confidential material detection system masks at least one preview image frame and generates an image set from the preview image data with the at least one preview image frame masked. The image set is output for storage or display.

### BACKGROUND

As technology has advanced our uses for mobile devices have expanded. One such use is small mobile devices, such as smartphones, which have become increasingly powerful despite their small size. These mobile devices provide a great deal of portable processing power but are not without their problems. One such problem is that as imaging capabilities of mobile devices increase, such devices are more frequently used for generating digital images and/or video in situations in which privacy is a concern. One solution to this problem is to manually turn off mobile devices in environments in which privacy is a priority. However, this also has problems because situations arise in which access to the functionality of such mobile devices is desired for communicating, route planning, and so forth. Trying to balance maintaining access to functionality of mobile devices while preventing exposure of sensitive information in the presence of such devices can be challenging for users, leading to user frustration with their devices.

### BRIEF DESCRIPTION OF THE DRAWINGS

Embodiments of a mobile device with confidential material detection are described with reference to the following drawings. The same numbers are used throughout the drawings to reference like features and components:

FIG. 1 illustrates an example system implementing the techniques discussed herein;

FIG. 2 illustrates an example implementation of a confidential material detection system in accordance with the techniques discussed herein;

FIG. 3 illustrates various mobile devices that are operable to implement the techniques discussed herein;

FIGS. 4-8 illustrate example articles that display confidential material and/or receive input of confidential material in accordance with the techniques discussed herein;

FIG. 9 illustrates an example user input gesture detectable by the confidential material detection system in accordance with the techniques discussed herein;

FIGS. 10-13 illustrate example processes for implementing the techniques discussed herein in accordance with one or more embodiments;

FIG. 14 illustrates various components of an example mobile device that can implement embodiments of the techniques discussed herein.

### DETAILED DESCRIPTION

A mobile device with confidential material detection is discussed herein. Generally, a mobile device can be a portable computing device such as a smartphone, tablet, laptop computer, etc. Such mobile devices often include cameras with image sensors for generating digital images and/or digital videos, supporting live video streaming operations, and so forth. For example, a mobile device such as a smartphone may include one or more camera image sensors configured to acquire two-dimensional digital images of people, objects, and/or other features within an environment of the mobile device. The digital images may include red, green, and blue (RGB) color data assigned to pixels of the digital images based on light detected by the one or more image sensors of the camera.

However, as mentioned above, privacy concerns can arise when such devices are present in an environment that includes sensitive information. As one example, in some situations sensitive information may be displayed by computing devices, papers, labels, and/or other objects. Such information may include personally identifiable information such as personal details associated with particular individuals (e.g., names, account numbers, addresses, and so forth), messages (e.g., emails, letters, text messages, etc.), passwords, and so forth. As another example, some security measures employ using sensitive information such as passcodes to control entry to facilities, vaults, or other protected areas. In these examples and others, the presence of mobile devices can potentially expose the sensitive information to unauthorized individuals. For instance, a mobile device operated to capture (e.g., generate) video data via an image sensor and stream the video data over the Internet can inadvertently display sensitive information to other individuals. In some instances, digital images acquired by a mobile device may be generated with the intent to depict a particular subject (e.g., an object or individual), but such images may unintentionally also depict sensitive information within the environment of the subject.

The techniques discussed herein improve the operation of a mobile device by detecting confidential material in preview image data, such as personally identifiable information, and accordingly masking preview image frames that depict the confidential material. To do so, one or more machine-learning models are employed to detect confidential material using image recognition. The one or more machine-learning models are trained using images that depict various articles that often display (or are used to input) confidential material such as personal identification cards, keypads, data entry fields, and so forth. Responsive to detection of confidential material, the preview image frames that depict the confidential material are masked, e.g., removed from an image set generated by the mobile device or obscured (e.g., blurred or replaced) within the image set. The image set is output by the device for storage or display. The masking of the preview image frames can occur automatically (e.g., without user input). The masked and unmasked preview image frames, once processed to generate the image set, can be automatically discarded (e.g., removed from the mobile device). In this way, unintentional exposure of the confidential material in the image set generated by the mobile device can be prevented, and storage space (e.g., memory) of the mobile device can be conserved.

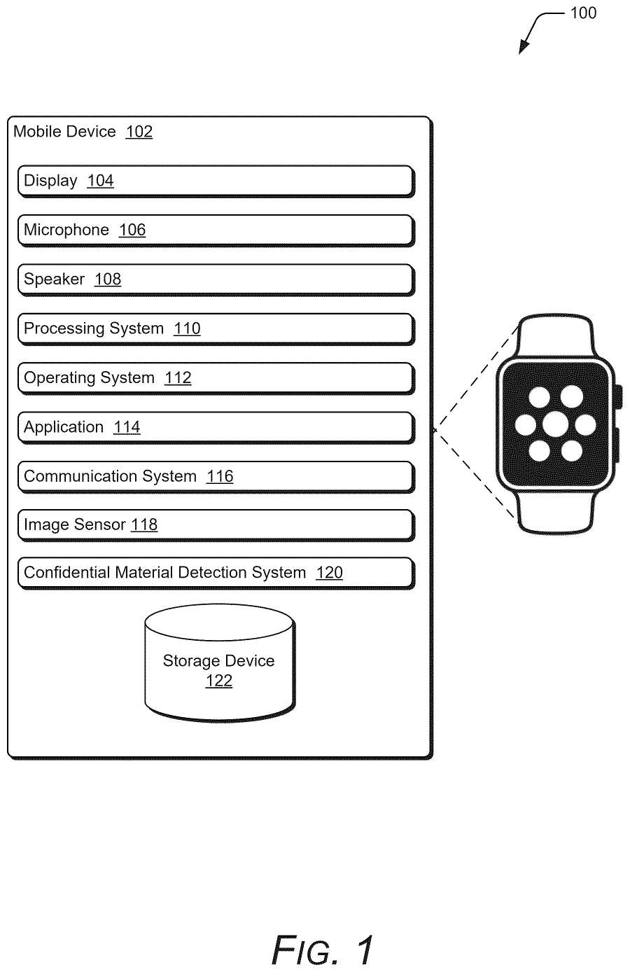

FIG. 1 illustrates an example system 100 implementing the techniques discussed herein. The system 100 includes a mobile device 102 that can be, or include, many different types of computing or electronic devices. For example, the mobile device 102 can be a smartphone or other wireless phone, a camera (e.g., compact or single-lens reflex), a wearable device (e.g., a smartwatch, an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, and so forth. Although typically a smaller device, the mobile device 102 can be larger (e.g., a tablet or phablet computer, a notebook computer (e.g., netbook or ultrabook), a laptop computer, and so forth.

In the implementation shown, the mobile device 102 includes a display 104. The display 104 can be configured as any suitable type of display, such as an organic light-emitting diode (OLED) display, active matrix OLED display, liquid crystal display (LCD), in-plane shifting LCD, and so forth. The display 104 can be touch enabled or not touch enabled. A touch-enabled device refers to a device that receives touch inputs via the display (e.g., a touchscreen). A touch-enabled device may also receive inputs via other input mechanisms, such as trackpad, mouse, physical keyboard, and so forth. A non-touch-enabled device refers to a device that does not receive touch inputs via the display (e.g., a touchscreen). Accordingly, a non-touch-enabled receives inputs via other input mechanisms, such as trackpad, mouse, physical keyboard, and so forth.

It should be appreciated that in some implementations, the mobile device 102 can be configured without the display 104. For example, the mobile device 102 may be a smart pin, ear-mounted device, or other type of computing device that does not include the display 104.

The mobile device 102 also includes a microphone 106 and a speaker 108 in the depicted implementation. The microphone 106 can be configured as any suitable type of microphone incorporating a transducer that converts sound into an electrical signal, such as a dynamic microphone, a condenser microphone, a piezoelectric microphone, and so forth. The speaker 108 can be configured as any suitable type of speaker incorporating a transducer that converts an electrical signal into sound, such as a dynamic loudspeaker using a diaphragm, a piezoelectric speaker, non-diaphragm based speakers, and so forth.

The mobile device 102 also includes a processing system 110 that includes one or more processors, each of which can include one or more cores. The processing system 110 is coupled with, and may implement functionalities of, any other components or modules of the mobile device 102 that are described herein. In one or more embodiments, the processing system 110 includes a single processor having a single core. Alternatively, the processing system 110 includes a single processor having multiple cores or multiple processors (each having one or more cores).

The mobile device 102 also includes an operating system 112. The operating system 112 manages hardware, software, and firmware resources in the mobile device 102. The operating system 112 manages one or more applications 114 running on the mobile device 102 and operates as an interface between applications 114 and hardware components of the mobile device 102.

The mobile device 102 also includes a communication system 116. The communication system 116 is operable to manage communication with various other devices. The mobile device 102 can be connected to one or more external devices and communicate with the external devices using any of a variety of wired or wireless connections, such as USB, USB-C, WiFi™, WiFi™ IP (Internet Protocol), USB IP, DisplayPort, High-Definition Multimedia Interface (HDMI), and so forth.

The mobile device 102 also includes an image sensor 118. The image sensor 118 is operable to acquire digital images of objects and other features within an environment of the mobile device 102. For example, the image sensor 118 may be part of a camera assembly including a lens and other components to support acquisition of digital images (e.g., digital photographs) using the image sensor 118. The image sensor 118 includes a plurality of photosensitive elements that receive light from the environment of the mobile device 102 and generate electronic signals indicating characteristics of the received light such as intensity, wavelength, and so forth. The electronic signals from the photosensitive elements are used by the mobile device 102 to assign values (e.g., color or grayscale values) to pixels in pixel data associated with the digital images.

The image sensor 118 can acquire image data in various modes. Such modes may include, for example, a continuous imaging mode and a shuttered mode. In the continuous imaging mode, the image sensor 118 continuously acquires preview image data in real-time and without interruption. For example, while in the continuous imaging mode, the image sensor 118 generates preview image frames continuously at a pre-determined rate or a rate specified by a user of the mobile device 102 via user input. The rate of preview image frame generation may be, for example, fifteen preview image frames per second, thirty preview image frames per second, sixty preview image frames per second, etc. Therefore, while operating in the continuous imaging mode, the preview image data generated by the image sensor 118 includes a plurality of preview image frames generated over a span of time (e.g., a duration of operating in the continuous imaging mode). In some instances, the preview image data may be formatted as video data. In the shuttered mode, the image sensor 118 is operable to acquire individual preview image frames or a series of preview image frames including a pre-defined number of preview image frames responsive to input received by the mobile device 102. The input may include, for example, user input applied via one or more physical buttons of the mobile device 102, touchscreen input, and so forth.

In some implementations, the image sensor 118 may default to operating in the continuous imaging mode following power-on of the mobile device 102. Power-on of the mobile device 102 includes, for example, adjustment of the mobile device 102 from an “off” condition in which mobile device 102 is inactive and not processing data, to an “on” condition in which the mobile device 102 is active and employing resources supporting operation of the operating system 112, applications 114, and so forth. As one example, the mobile device 102 may be configured to be worn by a user (e.g., as a smartwatch or other type of worn device) and may operate with the image sensor 118 in the continuous imaging mode until receiving user input to deactivate the continuous imaging mode (e.g., user input to turn off the image sensor 118 or adjust the image sensor 118 to a different operating mode such as the shuttered mode). The user input may include, for instance, touch applied to one or more physical buttons of the mobile device 102, selection of one or more graphical user interface elements displayed by the display 104, and so forth.

Different input styles are supported by the operating system 112 and applications 114. In one or more embodiments, the mobile device 102 supports a gesture-based input style and a non-gesture-based input style. The gesture-based input style refers to receiving user inputs that are gestures. The gestures may be applied to a touch sensitive device (e.g., display 104 configured as a touchscreen, a trackpad, etc.). In some implementations, gestures performed in a space within a field of view of the image sensor 118 may be detected by the image sensor 118 and used to control functionality of the mobile device 102 as described further below. Gestures can include swipes, a touch and hold actions (e.g., applied to the display 104 configured as a touchscreen), multi-finger swipes or movements, finger or hand movement patterns, combinations thereof, and so forth. The non-gesture-based input style refers to receiving user inputs that are not gestures, such as engagement of one or more buttons (e.g., mouse clicks on a virtual button, pressing a physical button), keyboard keys, and so forth. Although these one or more buttons in a non-gesture-based input style may be virtual buttons displayed on the display 104 and may be selected by tapping on the virtual button, the buttons are either activated if touched or not activated if not touched, there is no movement across the display 104 (e.g., no swipe) and no touch and hold (the button is either touched or not touched).

The mobile device 102 also includes a confidential material detection system 120 that can be implemented in a variety of different manners. For example, the confidential material detection system 120 can be implemented as multiple instructions stored on computer-readable storage media and that can be executed by the processing system 110. Additionally or alternatively, the confidential material detection system 120 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

The mobile device 102 also includes a storage device 122. The storage device 122 can be implemented using any of a variety of storage technologies, such as magnetic disk, optical disc, Flash, or other solid state memory, and so forth. The storage device 122 can store various program instructions and data for any one or more of the operating system 112, application 114, and the confidential material detection system 120.

The confidential material detection system 120 is employed by the mobile device 102 for detection of confidential material in image data generated by the image sensor 118 of the mobile device 102. The confidential material detection system 120 is operable to detect the confidential material and perform operations as described herein responsive to the detection of confidential material. To do so, the confidential material detection system 120 employs at least one machine-learning model trained to detect confidential material in image data. For example, a machine-learning model may process preview image frames generated by the mobile device 102 substantially in real-time (e.g., as the preview image frames are generated) to determine whether the preview image frames depict confidential material.

As one example of processing preview image frames substantially in real-time, the confidential material detection system 120 may acquire a first preview image frame and a second preview image frame sequentially using the image sensor 118. The first preview image frame and the second preview image frame may be acquired at a rate of thirty preview frames per second, as one non-limiting example (e.g., with approximately 0.03 second elapsing between acquisition of the first preview image frame and acquisition of the second preview image frame). One or more machine learning models are operable to process the first preview image frame before the second preview image frame is acquired (e.g., within the approximately 0.03 second duration between acquiring the first preview image frame and acquiring the second preview image frame). In some implementations, the rate of acquiring the preview image frames may be higher (e.g., sixty preview image frames per second), and the one or more machine-learning models are operable to process each preview image frame before acquiring the next preview image frame even at such high rates of preview image frame acquisition.

To support such high speeds of processing of the preview image frames, the one or more machine learning models can be trained specifically to process the preview image frames to detect confidential material while ignoring other features depicted by the preview image frames. For example, the one or more machine-learning models may be trained using images depicting confidential material without being trained on other types of images depicting other subject matter (e.g., human faces). As a result, a processing speed of the one or more machine-learning models can be much faster (e.g., twice as fast) compared to machine-learning models trained to recognize other types of media (e.g., other imagery).

Additionally, a resulting size of the one or more machine-learning models may be much smaller (e.g., half the size) compared to machine-learning models trained on other types of media. While some systems employ remote machine-learning models that are accessible via a network (e.g., cloud-based machine-learning models) to perform operations such as facial recognition, the reduced size of the one or more machine-learning models implementing the described techniques enables the one or more machine-learning models to be stored locally within a memory of the mobile device 102 (e.g., non-transitory memory of storage device 122). The local storage of the one or more machine-learning models can further increase the processing speed of the preview image frames by the one or more machine-learning models to support the substantially real-time processing described above. However, the storage location of the one or more machine-learning models is non-limiting, and in some implementations the one or more machine-learning models may be accessible over a network (e.g., via wired or wireless electronic communications between the mobile device 102 and one or more remote systems implementing the one or more machine-learning models using cloud-based storage).

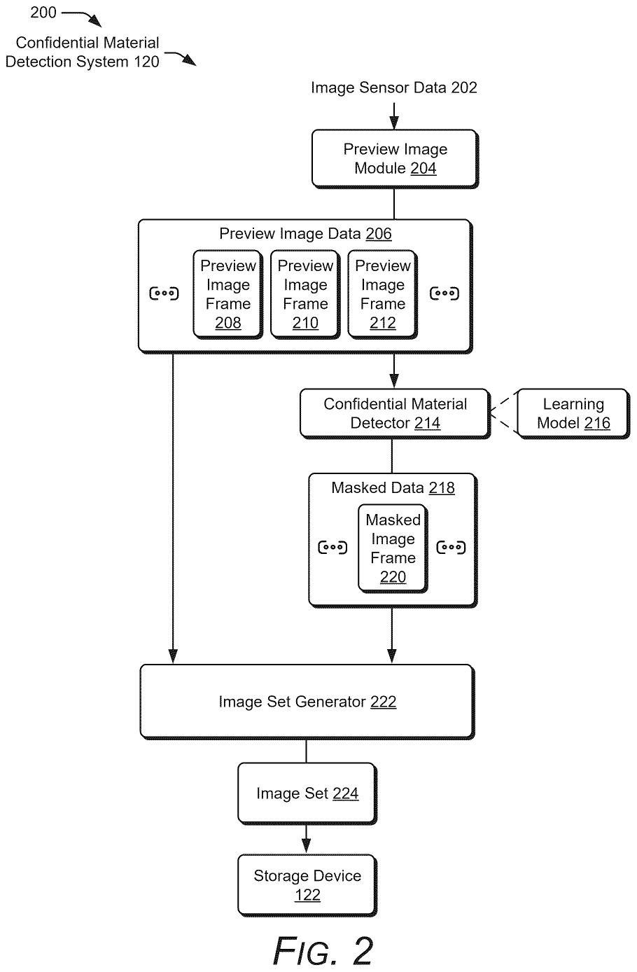

FIG. 2 illustrates an example 200 showing an implementation of the confidential material detection system 120. In particular, various modules of the confidential material detection system 120 are shown performing operations for confidential material detection.

Image sensor data 202 is generated by the image sensor 118 and provided to the preview image module 204. The image sensor data 202 includes data (e.g., electronic signals) acquired from (e.g., output by) a plurality of photosensitive elements of the image sensor 118. For example, the image sensor data 202 may include light intensity levels and color detected by individual photosensitive elements of the image sensor 118.

The preview image module 204 processes the image sensor data 202 to acquire (e.g., generate) preview image data 206. For example, the preview image module 204 processes the data describing the light intensity levels and color detected by the individual photosensitive elements of the image sensor 118 to form at least one preview image. The preview image data 206 includes one or more preview image frames generated based on the image sensor data 202. In the depicted example, the preview image data 206 is shown including a first preview image frame 208, a second preview image frame 210, and a third preview image frame 212. The preview image frames may be ordered according to a sequence in which the preview image frames are acquired.

The preview image frames are digital images depicting the subject matter imaged by the image sensor 118. The preview image frames may be maintained temporarily in a memory of the mobile device 102 for further processing by the confidential material detector 214.

The preview image data 206 is provided to (e.g., acquired by) the confidential material detector 214. The confidential material detector 214 processes the preview image data 206 using a learning model 216. The learning model 216 includes at least one machine-learning model trained to identify confidential material depicted by the preview image data 206.

A “machine-learning model” refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc. In some implementations, the learning model 216 includes at least one region-based convolutional neural network trained to identify the confidential material.

At least one machine-learning model included by the learning model 216 is trained on data describing confidential material. For example, the training data for the at least one machine-learning model may include images of keypads, data fields (e.g., data entry fields such as password fields, message recipient and/or sender fields, text message entry fields, etc.), personally identifiable information (e.g., names, addresses, phone numbers, account numbers, passport photos, etc.), personal identification articles (e.g., identification cards, identification papers, travel papers, etc.), account identification articles (e.g., library cards, membership cards and/or papers, banking cards, etc.), and so forth. In some instances, the training data may include pairs of images. For example, pairs of images may include images showing data fields that are unpopulated with data, as well as images of data fields that are populated with data (e.g., names, dates, and/or other data).

In implementations, processing the preview image data 206 occurs substantially in real-time as the preview image data 206 is acquired. For example, the image sensor data 202 may be provided continuously (e.g., without interruption) to the preview image module 204, and the preview image module 204 may generate respective preview image frames by the processing of the image sensor data 202 immediately as the image sensor data 202 is received.

In processing the preview image data 206 using the learning model 216, the confidential material detector 214 determines whether the preview image frames included by the preview image data depict confidential material. Confidential material as described herein refers to objects, imagery, or other features that display confidential information and/or are used for input of confidential information. Confidential information may include, for example, usernames, passwords, personal identification numbers, names, postal addresses, phone numbers, email addresses, emails, text messages, and so forth. However, the above examples of confidential information are non-limiting.

In some implementations, at least one machine-learning model is trained to identify confidential material by identifying indicators associated with confidential material that are proximate to sensitive information. For example, a machine-learning model of the learning model 216 (e.g., a CNN) may be trained to identify articles based on a size, shape, color, relative arrangement of features, and/or other attributes of the articles. The machine-learning model may detect the articles and classify the articles as containing confidential material based on the attributes of the articles even if sensitive information displayed by the articles is not directly depicted in the preview image data 206.

As one example, the machine-learning model may be trained to identify identification cards having a particular length to width ratio. During conditions in which an identification card having the particular length to width ratio is depicted in one or more preview image frames of the preview image data 206, the machine-learning model determines that the one or more preview image frames depict confidential material even if sensitive information included by the identification card such as a name, account number, etc. is not visible in the one or more preview image frames.

Other articles may also be identifiable by the machine-learning model based on their attributes. For example, the machine-learning model may determine that preview image frames depicting data entry fields having a particular size, shape, etc. include confidential material even if sensitive information such as account numbers and/or passwords have not been entered into the data entry fields.

Responsive to detecting confidential material in at least one preview image frame of the preview image data 206, the confidential material detector 214 generates masked data 218. The masked data 218 describes one or more of the preview image frames of the preview image data 206 that include confidential material as detected by the confidential material detector 214. In the depicted example, the masked data 218 includes one or more masked image frames, such as a masked image frame 220. Each masked image frame is associated with a respective preview image frame in the preview image data 206. For example, the masked image frame may be associated with one of the first preview image frame 208, the second preview image frame 210, or the third preview image frame 212.

The masked data 218 can include a list (e.g., an array, a table, etc.) with a plurality of entries that specify the preview image frames to be masked. For example, the masked image frame 220 may be an entry in the list of the masked data 218 specifying the corresponding preview image frame of the preview image data 206 to be masked.

In some implementations, the confidential material detector 214 detects confidential material in one or more preview image frames and identifies additional preview image frames for masking based on which preview image frames depict the confidential material. The additional preview image frames may be included in a frame range based on the preview image frames that depict the confidential material. For example, the frame range may include additional preview image frames adjacent to the preview image frames that depict the confidential material. Additional preview image frames “adjacent” to a given preview image frame as described herein refers to preview image frames that are acquired immediately prior to the given preview image or immediately following the given preview image frame in a sequence of acquiring the preview image frames (e.g., with no other preview image frames acquired between the given preview image frame and the additional preview image frames).

As one example, consider a scenario in which a sequence of acquiring the preview image frames includes first acquiring the first preview image frame 208. The second preview image frame 210 may be acquired immediately following acquisition of the first preview image frame 208 with no other preview image frames acquired between the first preview image frame 208 and the second preview image frame 210. The third preview image frame 212 may be acquired immediately following acquisition of the second preview image frame 210 with no other preview image frames acquired between the second preview image frame 210 and the third preview image frame 212. In this scenario, the first preview image frame 208, the second preview image frame 210, and the third preview image frame 212 form a series of preview image frames. In the series, the sequence of acquisition of the preview image frames begins with the first preview image frame 208, proceeds to the second preview image frame 210 second, and then proceeds to the third preview image frame 212. The first preview image frame 208 and the third preview image frame 212 may thus be referred to as adjacent to the second preview image frame 210. In this scenario, a frame range based on the second preview image frame 210 may include each preview image frame adjacent to the second preview image frame 210, namely, the first preview image frame 208 and the third preview image frame 212. By masking a given preview image frame that includes confidential material and additionally masking preview image frames in a series that includes the given preview image frame (e.g., preview image frames adjacent to the given preview image frame), a likelihood of exposure of confidential material in image sets generated by the confidential material detection system may be reduced.

In some implementations, responsive to generating the masked data 218, the confidential material detector 214 outputs an indication that one or more masked image frames have been generated and that the one or more masked image frames are associated with one or more preview image frames. The indication may include, for example, one or more visual indicators, one or more audio indicators, and/or vibration of the mobile device 102. As an example, the indication may include visual indicators such as symbols, text, and/or other content displayed at a display screen of the mobile device 102. The visual indicators may additionally or alternatively include illumination of indicator lights of the mobile device 102. Audio indicators may include audible tones and/or other sounds output by the speaker 108. Vibration of the mobile device 102 may result from energization of a vibration motor of the mobile device 102.

In some implementations, the confidential material detector 214 outputs a prompt for receiving user confirmation via user input to mask the one or more preview image frames. For example, the prompt may be a graphical user interface element displayed via a display screen of the mobile device 102, an illumination of an indicator light of the mobile device 102, and so forth. The user input may include interaction with one or more buttons of the mobile device 102 (e.g., pressing one or more physical buttons or representations of buttons in a graphical user interface), verbal input received via microphone 106 (e.g., spoken words or other sounds), gesture input (e.g., gestures applied to display 104 and/or gestures detected by image sensor 118), and so forth. Responsive to receiving user confirmation via the user input to mask the one or more preview image frames, the confidential material detector 214 provides the masked data 218 to the image set generator 222. However, the user input to the prompt can also deny the masking of the one or more preview image frames (e.g., deny confirmation). As a result, the masked data 218 may be withheld from the image set generator 222 (e.g., removed from the memory of the mobile device 102).

In some implementations, if user input is not received at the prompt for user confirmation within a pre-determined duration (e.g., ten seconds, thirty seconds, etc.), the confidential material detector 214 may automatically (e.g., without user input or other human interaction) provide the masked data 218 to the image set generator 222. In other implementations, if user input is not received at the prompt for user confirmation within the pre-determined duration, the confidential material detector 214 may automatically discard the masked data 218 (e.g., remove the masked data 218 from memory of the mobile device 102). The confidential material detection system 120 can be configured to automatically provide the masked data 218 to the storage device 122 or discard the masked data 218 following the duration as described above based on settings stored within a memory of the mobile device 102. In some implementations, the settings may be user-configurable (e.g., adjustable via user input). Thus, the confidential material detection system 120 is configurable in a variety of ways that support automatic masking of image data including confidential material and/or user-confirmed masking of image data including confidential material.

In some implementations, the confidential material detector 214 outputs a prompt for receiving user input to remove one or more of the masked image frames from the masked data 218. For example, the prompt may be a graphical user interface element displayed via a display screen of the mobile device 102, an illumination of an indicator light of the mobile device 102, and so forth. The user input to remove the one or more masked image frames from the masked data 218 may include input to the graphical user interface element (e.g., via a keyboard, touchscreen, etc.), input to one or more user interface buttons of the mobile device 102, and so forth. In some implementations, the user input includes one or more gestures detectable via the image sensor 118. The gestures may include gestures performed by a user of the mobile device 102. For example, the user may perform a gesture in a space in front of the image sensor 118, and the image sensor 118 detects the performed gesture.

Responsive to receiving user input to remove the one or more masked image frames from the masked data 218, the confidential material detector 214 updates the masked data 218 accordingly. The updated mask data may be provided to the image set generator 222.

The image set generator 222 receives and processes the preview image data 206. In situations in which the confidential material detector 214 detects confidential material in the preview image data 206, the masked data 218 is also provided to the image set generator 222 and processed by the image set generator 222. The image set generator 222 is operable to mask preview image frames included by the preview image data 206 based on the masked image frames specified by the masked data 218.

As an example, the masked data 218 is shown including the masked image frame 220. The masked image frame 220 corresponds to one of the preview image frames included by the preview image data 206, such as the second preview image frame 210. The masked data 218 is used by the image set generator 222 for masking preview image frames (e.g., the second preview image frame 210) included by the preview image data 206.

In some implementations, masking preview image frames includes applying a filter to the masked preview image frames. For example, the image set generator 222 can apply a blurring filter (e.g., gaussian blur) to the masked preview image frames to obscure (e.g., render unintelligible, cover, etc.) information depicted in the masked preview image frames. In some implementations, masking preview image frames includes deleting the preview image frames from memory (e.g., removing the masked preview image frames from the preview image data 206). In some implementations, masking preview image frames includes replacing the masked preview image frames with blank image frames and/or image frames including pre-determined information content. For example, masking a preview image frame can include deleting the preview image frame and replacing the deleted preview image frame with a solid black fill image (e.g., an image frame in which all pixels have a same black color). As another example, masking a preview image frame can include deleting the preview image frame and replacing the deleted preview image frame with a pre-determined image including text and/or other indicators describing that the deleted preview image frame included confidential material.

In some implementations, applying the filter to a masked preview image frame may include applying the filter to portions of the preview image frame that depict confidential material while bypassing applying the filter to portions of the preview image frame that do not depict confidential material. For instance, the one or more machine-learning models of the learning model 216 employed by the confidential material detector 214 can be operable to detect areas within a preview image frame that include confidential material. As one example, at least one of the machine-learning models may be a region-based convolutional neural network. The confidential material detector 214 can indicate the areas in the masked data 218. The image set generator 222 can process the masked data 218 and the preview image data 206 and generate the image set 224 with the detected areas obscured while other subject matter depicted by the image set 224 is not obscured. For example, a given image frame in the image set 224 can concurrently include obscured areas corresponding to the location of confidential material and unobscured areas corresponding to locations in which confidential material was not detected.

In some implementations, responsive to masking one or more preview image frames, the image set generator 222 outputs an indication that the one or more preview image frames have been masked. The indication may include, for example, one or more visual indicators, one or more audio indicators, and/or vibration of the mobile device 102. The visual indicators, audio indicators, and vibration may be similar to the visual indicators, audio indicators, and vibration, respectively, described above with reference to the confidential material detector 214.

The image set generator 222 outputs an image set 224 based on the received preview image data 206. In situations in which the confidential material detection system 120 detects that the preview image data 206 does not include confidential material, the image set 224 includes each preview image frame included by the preview image data 206. However, in some situations the confidential material detection system 120 detects confidential material in the preview image data 206, and the masked data 218 is generated and provided to the image set generator 222 for masking one or more of the preview image frames as described above. In such situations, the image set 224 includes the preview image frames of the preview image data 206 that are not associated with masked image frames in the masked data preview image data 206, and the preview image frames associated with masked image frames are masked (e.g., omitted from the image set 224, or obscured in the image set 224 via blurring or replacement as described above).

Outputting the image set 224 can include storing the image set 224 to the storage device 122 and/or other storage (e.g., cloud-based storage). In some implementations, outputting the image set 224 can include displaying the image set 224 via a display device, such as a display screen of the mobile device 102 or a display screen of a computing device external to the mobile device 102.

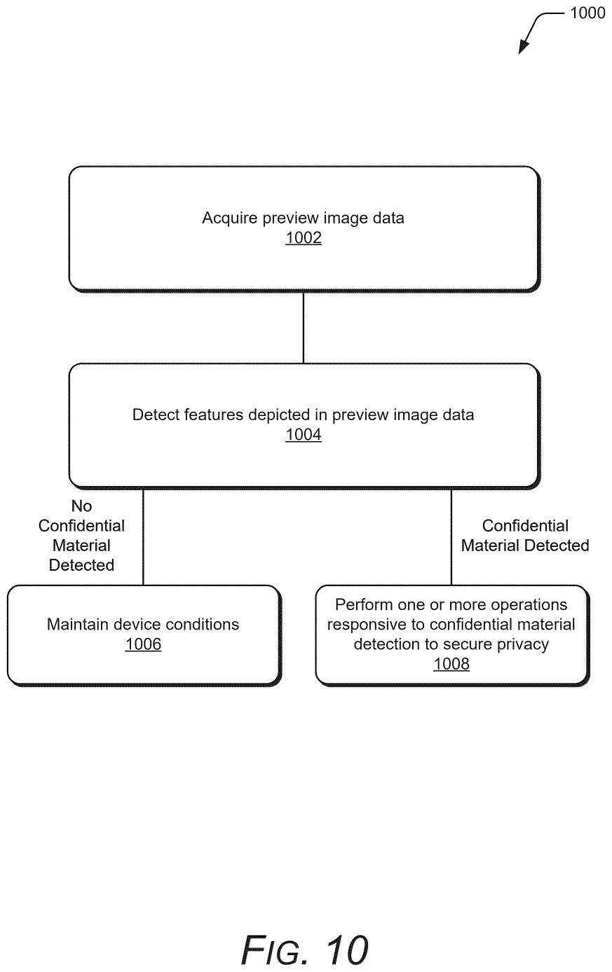

In some implementations, the image set generator 222 outputs a prompt for receiving user input to unmask at least one preview image frame. For example, the prompt may be a graphical user interface element displayed via a display screen of the mobile device 102, an illumination of an indicator light of the mobile device 102, and so forth. The user input to unmask the at least one preview image frame may include input to the graphical user interface element (e.g., via a keyboard, touchscreen, etc.), input to one or more user interface buttons of the mobile device 102, and so forth. In some implementations, the user input includes one or more gestures detectable via the image sensor 118 as described above. An example gesture is depicted by FIG. 9 and described further below.

Responsive to receiving user input to unmask one or more preview image frames, the image set generator 222 updates the image set 224 to include the one or more unmasked preview image frames and outputs the updated image set. Updating the image set 224 and outputting the updated image set may include storing the updated image set to the storage device 122. By controlling a content of the image set 224 based on detection of confidential material as described above, the confidential material detection system 120 can prevent exposure of the confidential material to unauthorized individuals.

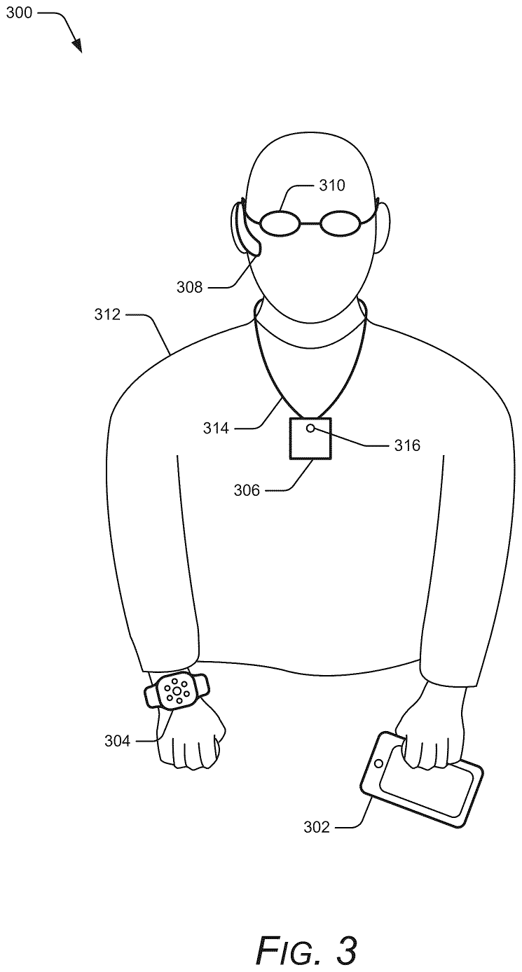

FIG. 3 illustrates an example 300 depicting various mobile devices that are operable to implement the described techniques for confidential material detection. In particular, a smartphone 302, a smart watch 304, a smart pin 306, an ear-mounted device 308, and smart glasses 310 are shown. The various devices can be worn or otherwise fixed to a body of a user 312 in some instances. For example, the smart watch 304 is depicted fixed to a wrist of the user 312, the smart glasses 310 are depicted supported at a face of the user 312, the ear-mounted device 308 is depicted supported at an ear of the user 312, and the smart pin 306 is depicted supported at a chest of the user 312 by a lanyard 314. Some devices, such as the smartphone 302, can be adjusted from being worn by the user 312 (e.g., stowed to a holster) to being held by the user, or vice versa.

The devices depicted by FIG. 3 are non-limiting example devices that can implement the confidential material detection system 120. The depicted devices can include components that are similar to, or the same as, the components of the mobile device 102. For instance, the smartphone 302 can include the components such as the display 104, microphone 106, speaker 108, etc. included by the mobile device 102. Each of the depicted devices can include an image sensor, such as the image sensor 118, employed for acquiring the image sensor data 202 to be processed by the preview image module 204 for generating the preview image data 206. As one example, the smart pin 306 is depicted including an image sensor 316, and the image sensor 316 may be the same as the image sensor 118 described above.

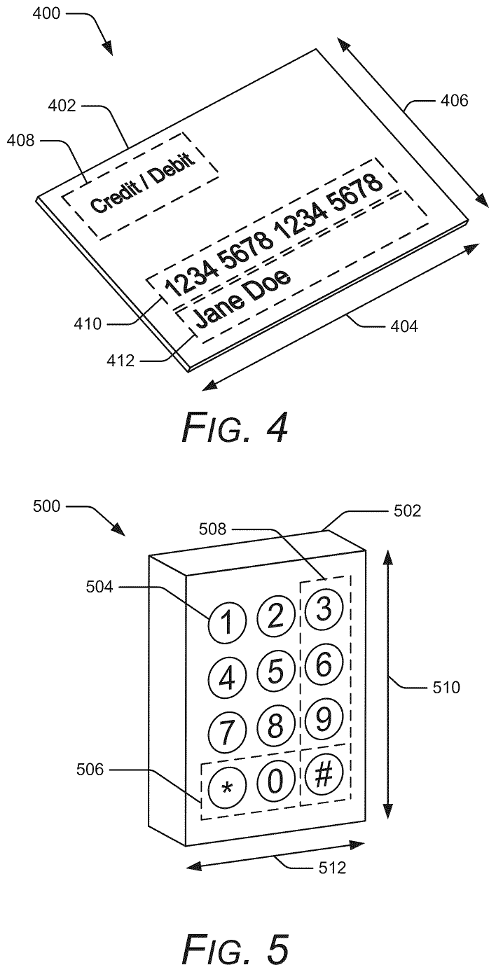

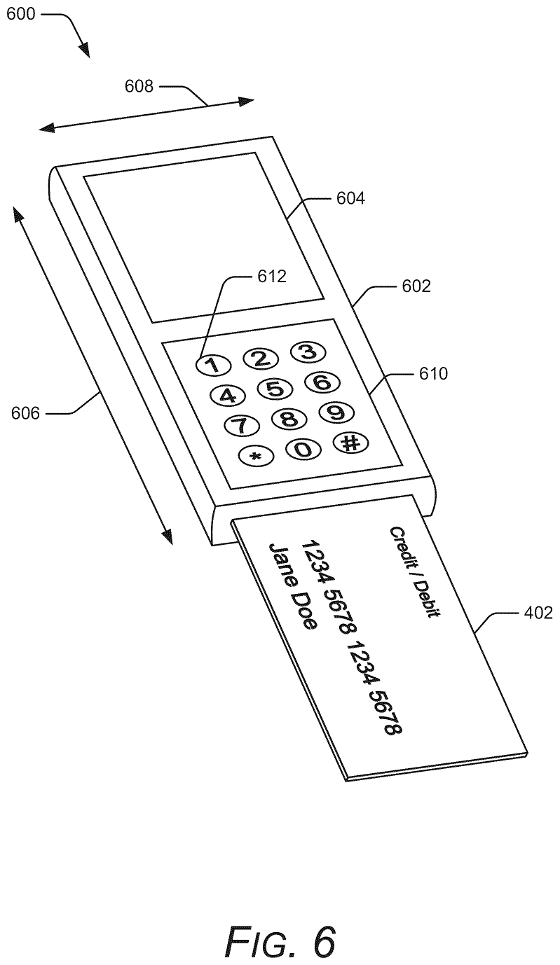

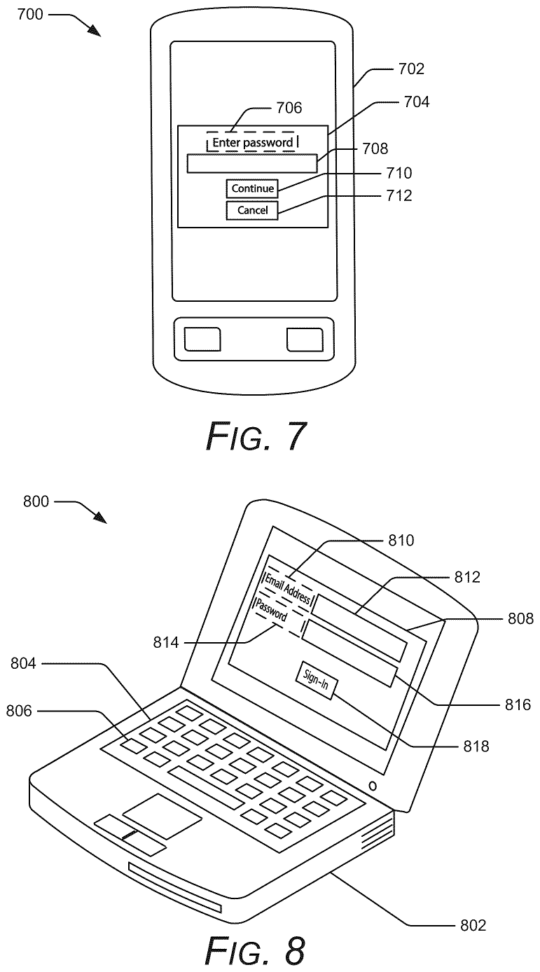

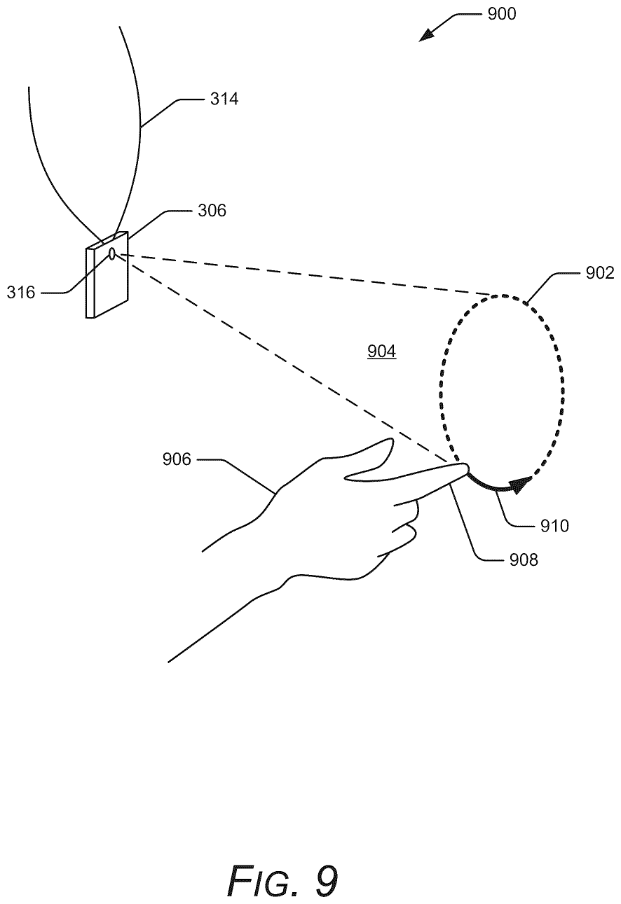

FIGS. 4-8 illustrate various non-limiting example articles that can be identified as showing confidential material by the confidential material detection system 120 according to the techniques described herein. In particular, FIG. 4 illustrates an example 400 showing an account identification card 402, FIG. 5 illustrates an example 500 showing a number keypad 502, FIG. 6 illustrates an example 600 showing a card reader 602 with the account identification card 402, FIG. 7 illustrates an example 700 showing a smartphone 702, and FIG. 8 illustrates an example 800 showing a computing device 802.

In FIG. 4, the depicted account identification card 402 is one type of identification card that can be detected by the confidential material detector 214 as including confidential material. To do so, the one or more machine-learning models of the learning model 216 of the confidential material detector 214 can be trained using training data (e.g., images) depicting various types of articles (e.g., identification cards) and information displayed by such articles. For example, the one or more machine-learning models may be trained using images depicting sequences of characters (e.g., letters and/or numbers). The sequences may have lengths (e.g., number of characters) and groupings of characters that are often associated with confidential information such as account numbers, addresses, telephone numbers, email addresses, names, and so forth. The training data can further include the positions of such information relative to edges of articles such as identification cards, dimensions (e.g., length, width, and depth) frequently used for the articles, and so forth.

Consider a scenario in which the account identification card 402 is depicted in one or more preview image frames of the preview image data 206. The confidential material detector 214 receives the preview image data 206 and employs the one or more machine-learning models of the learning model 216 to detect confidential material in the preview image frames. The one or more machine-learning models can detect features of the account identification card 402 such as an aspect ratio of the account identification card 402 (e.g., the ratio of the length 404 to the width 406 of the account identification card 402). The one or more machine-learning models can further detect information displayed by the account identification card 402 such as an account type 408, an account number 410, and a name 412 associated with the account. Responsive to detection of the features described above by the one or more machine-learning models, the confidential material detector 214 generates masked data 218 used by the image set generator 222 to mask the preview image frames in which the detected confidential material is depicted. In some instances, the masking can be performed substantially in real-time, e.g., as the preview image frames are processed by the confidential material detector 214. In some instances, image frames within a range that is based on the masked image frames may also be masked as described above, e.g., in situations in which a series of preview image frames is temporarily stored and provided to the image set generator 222 as the series.

In FIGS. 5-8, the depicted devices also include features that are detectable by the one or more machine-learning models of the learning model 216 of the confidential material detector 214 as relating to confidential material. For example, the number keypad 502 shown by FIG. 5 includes a plurality of number keys 504, the number keys 504 are in a particular arrangement (e.g., four rows 506 and three columns 508), and the number keypad 502 has a particular aspect ratio (e.g., length 510 and width 512). The card reader 602 depicted by FIG. 6 includes a display screen 604, a particular length 606 and width 608, and a number keypad 610 including a plurality of number keys 612. The smartphone 702 shown by FIG. 7 displays a graphical user interface element 704 including a label 706. A data entry field 708, a continue button 710, and a cancel button 712. The computing device 802 shown by FIG. 8 includes a keypad 804 with a plurality of keys 806. The computing device 802 also displays a graphical user interface element 808 including an email address label 810 and email address entry field 812, a password label 814 and password entry field 816, and a sign-in button 818.

In some implementations, the confidential material detector 214 may weight particular features depicted by the preview image frames of the preview image data 206 based on a type or category of the features. In some instances, the weights may be implemented as scores associated with the features. For example, features such as the dimensions of an article (e.g., the length 404 and width 406 of the account identification card 402) may be identified by the confidential material detector 214 as belonging to a “dimensions” category of features, while other features such as the account number 410 may be identified as belonging to an “information” category of features. Scores associated with features in the “dimensions” category may be lower than scores associated with features in the “information” category. The one or more machine-learning models can detect the features relating to confidential material as well as the category of the features.

In some implementations in which the confidential material detector 214 employs weights as described above, the confidential material detector 214 can be configured to determine preview image frames for masking based on a total score associated with each preview image frame. For instance, responsive to the total score associated with a preview image frame being greater than a threshold score, the confidential material detector 214 masks the preview image frame. Responsive to the total score being equal to or less than the threshold score, the confidential material detector 214 does not mask the preview image frame. As a result, preview image frames that depict features such as an aspect ratio of an article may not be immediately masked unless additional features such as personal information (e.g., account number 410) are also depicted in the preview image frames to increase the total score associated with the preview image frames above the threshold score. The threshold score and the scores associated with various features may be pre-determined. By scoring detected features as described above, an accuracy of masking preview image frames that include confidential material may be increased.

FIG. 9 illustrates an example 900 showing a gesture 902 detectable as user input by the confidential material detection system 120. In the example, the user input gesture 902 is performed by a user (e.g., user 312) in a space 904 imageable by the image sensor 316 of the smart pin 306. The user's hand 906 and finger 908 move within the space 904 to perform the gesture 902, and the gesture 902 is detected by the confidential material detection system 120 using the image sensor 316. In the example 900, the gesture 902 includes a circular motion of the finger 908 of the user within the space 904 as indicated by arrow 910. However, the depicted gesture 902 is non-limiting and in some implementations the confidential material detection system 120 may be configured to detect gestures performed with different motions (e.g., an S-shaped motion, a triangular-shaped motion, etc.). The gesture 902 may be used as input to confirm or deny masking of preview image frames, to unmask preview image frames, and/or to perform other operations as described above.

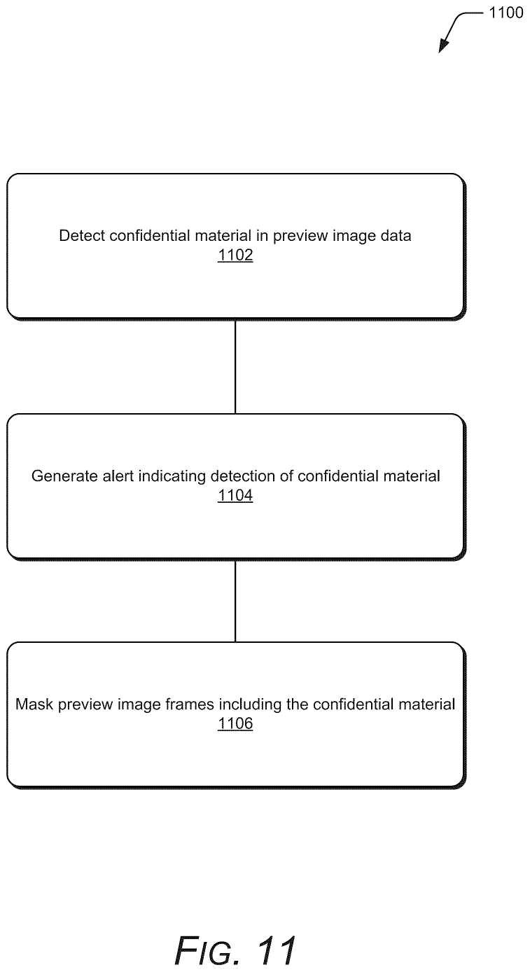

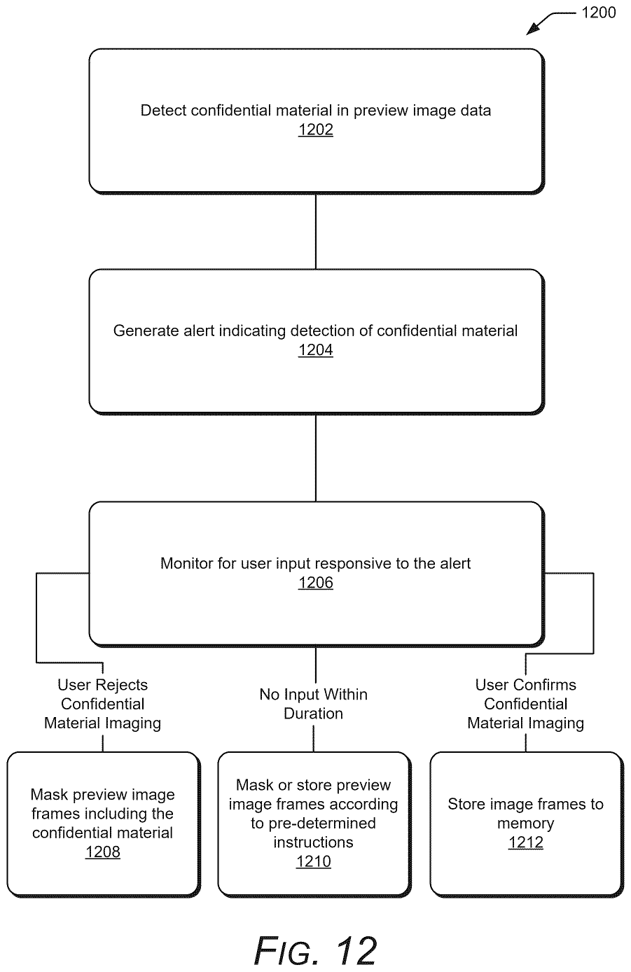

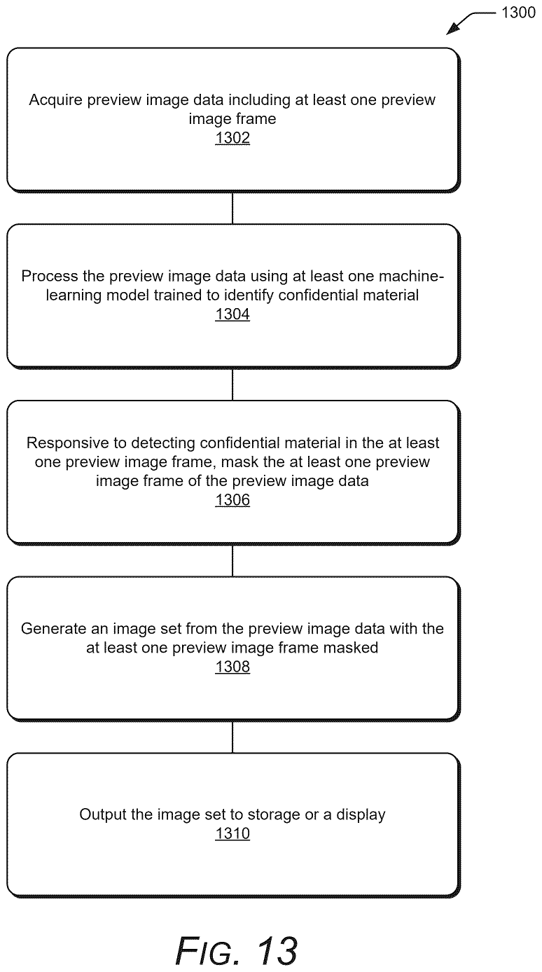

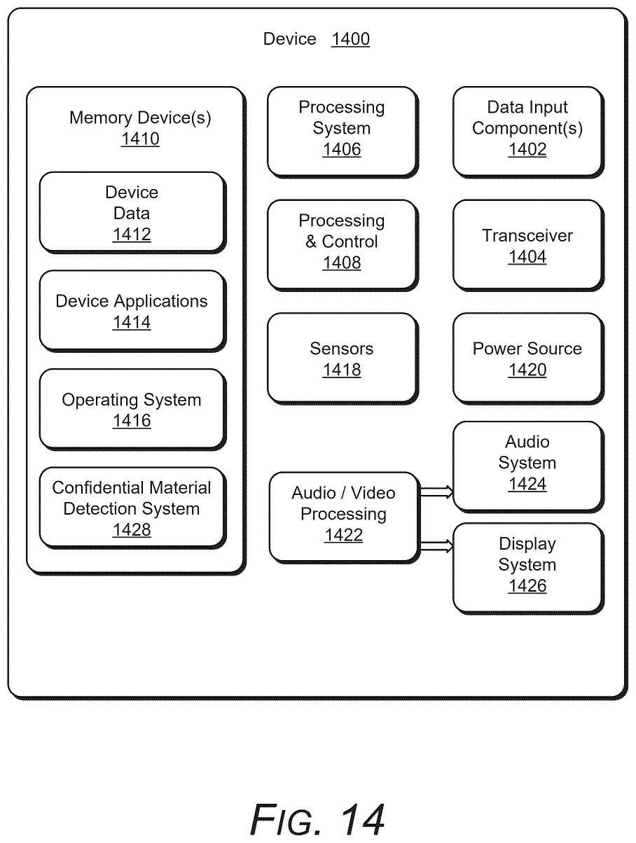

FIGS. 10-13 illustrate example processes for implementing the techniques discussed herein in accordance with one or more embodiments. Process 1000 depicted by FIG. 10, process 1100 depicted by FIG. 11, process 1200 depicted by FIG. 12, and process 1300 depicted by FIG. 13 are carried out by a confidential material detection system, such as the confidential material detection system 120 of FIG. 1, and can be implemented in software, firmware, hardware, or combinations thereof. The process 1000, the process 1100, the process 1200, and the process 1300 are shown as a set of acts and are not limited to the order shown for performing the operations of the various acts.

In the process 1000 depicted by FIG. 10, preview image data is acquired (act 1002). By way of example, the preview image data 206 is acquired (e.g., generated) by the preview image data 206 based on the image sensor data 202 generated by the image sensor 118 of the mobile device 102.

Features depicted in the preview image data are detected (act 1004). By way of example, the confidential material detector 214 processes the preview image data 206 and determines whether the features (e.g., objects) depicted by the preview image frames of the preview image data 206 include confidential material. The confidential material may be, for example, the features described above with reference to FIGS. 4-8.

Process 1000 proceeds based on whether confidential material is detected in the preview image data. If the preview image data does not include confidential material, then device conditions are maintained (act 1006). By way of example, maintaining the device conditions may include not masking preview image frames included by the preview image data 206.

However, if confidential material is included in the preview image data, then one or more operations are performed responsive to the detection of the confidential material to secure privacy (act 1008). By way of example, the one or more operations include generating masked data 218 via the confidential material detector 214 and providing the masked data 218 to the image set generator 222 for generation of the image set 224.

In the process 1100 depicted by FIG. 11, confidential material is detected in preview image data (act 1102). By way of example, the confidential material detector 214 processes the preview image data 206 and determines that the preview image data 206 depicts confidential information (e.g., usernames, passwords, account numbers, etc.).

An alert is generated indicating the detection of the confidential material (act 1104). By way of example, the alert includes illumination of one or more illumination elements (e.g., LEDs) of the mobile device 102, output of an audible indication (e.g., a tone, recorded speech, etc.), vibration of the mobile device 102 (e.g., via the vibration motor), and/or other type of alert.

Preview image frames including the confidential material are masked (act 1106). By way of example, the first preview image frame 208, the second preview image frame 210, and/or the third preview image frame 212 is masked by generation of the masked data 218 provided to the image set generator 222. The masked preview image frames are omitted from the image set 224 or obscured (e.g., blurred) in the image set 224.

In the process 1200 depicted by FIG. 12, confidential material is detected in preview image data (act 1202). As discussed above, the confidential material detector 214 processes the preview image data 206 and determines that the preview image data 206 depicts confidential information.

An alert is generated indicating the detection of the confidential material (act 1204). By way of example, the alert includes illumination of one or more illumination elements of the mobile device 102, output of an audible indication, vibration of the mobile device 102, and/or other type of alert.

Monitoring for user input responsive to the alert is performed (act 1206). By way of example, the confidential material detection system 120 monitors for user input which may include pressing one or more physical buttons of the mobile device 102, touch input applied to a touch-sensitive display of the mobile device 102 (e.g., display 104), audio input (e.g., speech or other sounds) received via the microphone 106 of the mobile device 102, one or more gestures performed by a user of the mobile device 102 (e.g., gesture 902), and so forth.

Process 1200 proceeds based on whether user input is received. If user input is received indicating that the user rejects confidential material imaging, then preview image frames including the confidential material are masked (act 1208). By way of example, a first gesture may include a circular motion performed by a user by moving the user's finger 908 in the space 904 imageable by the image sensor 316 in the direction indicated by arrow 910. The confidential material detection system 120 detects the first gesture via the image sensor 118 and masks preview image frames that depict confidential material.

If no user input is received within a duration, then preview image frames are masked or stored according to pre-determined instructions (act 1210). By way of example, the duration is pre-determined (e.g., stored in settings of the mobile device 102). The duration may be, for example, ten seconds, thirty seconds, one minute, and so forth. Further, the operations performed responsive to detection by the confidential material detection system 120 that no user input has occurred within the duration can be pre-determined (e.g., stored in the settings). For example, settings of the mobile device 102 can be user-configurable to specify that during conditions in which confidential material is detected and user input does not occur within the duration following the detection, the preview image frames depicting the confidential material are masked. Alternatively, the settings can specify that the preview image frames depicting the confidential material are not masked (e.g., stored to the storage device 122 and/or stored to another device over a network, for example, using cloud-based storage). Therefore, the user can configure the settings to specify the desired automatic operations performed by the confidential material detection system 120 in the absence of user input. As a result, the mobile device 102 can operate with the image sensor 118 in the continuous imaging mode, for example, with preview image frames depicting confidential material as detected by the confidential material detection system 120 being automatically masked or stored based on the settings of the mobile device 102.

If user input is received indicating that the user confirms confidential material imaging, image frames are stored to memory (act 1212). By way of example, a different, second gesture may include a circular motion performed by the user with the user's finger 908 moving in a direction opposite to the direction indicated by arrow 910. The confidential material detection system 120 detects the second gesture via the image sensor 118 and stores the preview image frames that depict confidential material without masking the preview image frames. For instance, the image set generator 222 generates the image set 224 using the preview image data 206 while discarding the masked data 218. By enabling the user to specify that the preview image frames should be masked using the first gesture and that the preview image frames should be stored without masking using the second gesture, the user can more easily control operation of the confidential material detection system 120.

In the process 1300 depicted by FIG. 13, preview image data including at least one preview image frame is acquired (act 1302). By way of example, the preview image data 206 is acquired (e.g., generated) by the preview image data 206 based on the image sensor data 202 generated by the image sensor 118 of the mobile device 102. The preview image data 206 includes at least one preview image frame such as the first preview image frame 208, the second preview image frame 210, and/or the third preview image frame 212.

The preview image data is processed using at least one machine-learning model trained to identify confidential material (act 1304). By way of example, the confidential material detector 214 processes the preview image data 206 using at least one machine-learning model of the learning model 216 trained to identify confidential material. The confidential material may be, for example, the features described above with reference to FIGS. 4-8.

Responsive to detecting confidential material in the at least one preview image frame, the at least one preview image frame of the preview image data is masked (act 1306). By way of example, the confidential material detector 214 generates masked data 218 including the masked image frame 220. The masked image frame 220 specifies one of the first preview image frame 208, the second preview image frame 210, or the third preview image frame 212 to be masked. The masked data 218 and the preview image data 206 are provided to the image set generator 222, and the image set generator 222 masks the corresponding preview image frame of the preview image data 206 based on the masked data 218.

An image set is generated from the preview image data with the at least one preview image frame masked (act 1308). By way of example, the image set generator 222 generates the image set 224 from the preview image data 206 with the preview image frame specified by the masked image frame 220 masked (e.g., omitted from the image set 224 or obscured in the image set 224).

The image set is output to storage or a display (act 1310). By way of example, the image set is output to the storage device 122 (e.g., stored in the storage device 122) and/or output to the display 104 (e.g., displayed by the display 104).

FIG. 14 illustrates various components of an example mobile device 1400 in which embodiments of confidential material detection can be implemented. The mobile device 1400 can be implemented as any of the devices described with reference to the previous FIG. s, such as any type of client device, mobile phone, tablet, computing, communication, entertainment, gaming, media playback, or other type of mobile device. In one or more embodiments the mobile device 1400 is a mobile device 102 and the confidential material detection system 1428 includes the confidential material detection system 120, described above.

The mobile device 1400 includes one or more data input components 1402 via which any type of data, media content, or inputs can be received such as user-selectable inputs, messages, music, television content, recorded video content, and any other type of text, audio, video, or image data received from any content or data source. The data input components 1402 may include various data input ports such as universal serial bus ports, coaxial cable ports, and other serial or parallel connectors (including internal connectors) for flash memory, DVDs, compact discs, and the like. These data input ports may be used to couple the mobile device 1400 to components, peripherals, or accessories such as keyboards, microphones, or cameras. The data input components 1402 may also include various other input components such as microphones, touch sensors, touchscreens, keyboards, and so forth.

The mobile device 1400 includes communication transceivers 1404 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The mobile device 1400 includes a processing system 1406 of one or more processors (e.g., any of microprocessors, controllers, and the like) or a processor and memory system implemented as a system-on-chip (SoC) that processes computer-executable instructions. The processing system 1406 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 1408. The mobile device 1400 may further include any type of a system bus or other data and command transfer system that couples the various components within the device. A system bus can include any one or combination of different bus structures and architectures, as well as control and data lines.

The mobile device 1400 also includes computer-readable storage memory devices 1410 that enable data storage, such as data storage devices that can be accessed by the mobile device, and that provide persistent storage of data and executable instructions (e.g., software applications, programs, functions, and the like). Examples of the computer-readable storage memory devices 1410 include volatile memory and non volatile memory, fixed and removable media devices, and any suitable memory device or electronic data storage that maintains data for mobile device access. The computer-readable storage memory can include various implementations of random access memory (RAM), read only memory (ROM), flash memory, and other types of storage media in various memory device configurations. The mobile device 1400 may also include a mass storage media device.

The computer-readable storage memory device 1410 provides data storage mechanisms to store the device data 1412, other types of information or data, and various device applications 1414 (e.g., software applications). For example, an operating system 1416 can be maintained as software instructions with a memory device and executed by the processing system 1406. The device applications 1414 may also include a device manager, such as any form of a control application, software application, signal-processing and control module, code that is native to a particular device, a hardware abstraction layer for a particular device, and so on.

The mobile device 1400 can also include one or more device sensors 1418, such as any one or more of an ambient light sensor, a proximity sensor, a touch sensor, an infrared (IR) sensor, accelerometer, gyroscope, thermal sensor, audio sensor (e.g., microphone), and the like. The mobile device 1400 can also include one or more power sources 1420, such as when the mobile device 1400 is implemented as a mobile device. The power sources 1420 may include a charging or power system, and can be implemented as a flexible strip battery, a rechargeable battery, a charged super-capacitor, or any other type of active or passive power source.

The mobile device 1400 additionally includes an audio or video processing system 1422 that generates one or both of audio data for an audio system 1424 and display data for a display system 1426. In accordance with some embodiments, the audio/video processing system 1422 is configured to receive call audio data from the transceiver 1404 and communicate the call audio data to the audio system 1424 for playback at the mobile device 1400. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for a mobile device with confidential material detection have been described in language specific to features or methods, the subject of the appended claims is not necessarily limited to the specific features or methods described. Rather, the specific features and methods are disclosed as example implementations of techniques for implementing a mobile device with confidential material detection. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a mobile device including: at least one memory; and at least one processor coupled with the at least one memory and configured to cause the mobile device to: acquire preview image data including at least one preview image frame; process the preview image data using at least one machine-learning model trained to identify confidential material; responsive to detecting confidential material in the at least one preview image frame, mask the at least one preview image frame of the preview image data; generate an image set from the preview image data with the at least one preview image frame masked; and output the image set to storage or a display.

In some aspects, the techniques described herein relate to a mobile device, wherein the at least one machine-learning model is trained on data describing data entry fields, keypads, personal identification articles, or account identification articles.

In some aspects, the techniques described herein relate to a mobile device, wherein the at least one processor is configured to cause the mobile device to: determine a series of preview image frames including the at least one preview image frame and one or more additional preview image frames adjacent to the at least one preview image frame in a sequence of the preview image data; and mask each preview image frame in the series of preview image frames.

In some aspects, the techniques described herein relate to a mobile device, wherein the at least one processor is configured to cause the mobile device to: mask the at least one preview image frame of the preview image data by deleting the at least one preview image frame from the preview image data.

In some aspects, the techniques described herein relate to a mobile device, wherein the at least one machine-learning model includes a region-based convolutional neural network.

In some aspects, the techniques described herein relate to a mobile device, wherein the mobile device is a wearable device including an image sensor configured to acquire the preview image data substantially continuously in real-time while the mobile device is worn.

In some aspects, the techniques described herein relate to a mobile device, wherein the at least one processor is configured to cause the mobile device to: output an indication that the at least one preview image frame has been masked responsive to masking the at least one preview image frame.

In some aspects, the techniques described herein relate to a mobile device, wherein the indication is a visual indicator or an audio indicator.

In some aspects, the techniques described herein relate to a mobile device, wherein the indication includes vibration of the mobile device by a vibration motor.

In some aspects, the techniques described herein relate to a mobile device, wherein the at least one processor is configured to cause the mobile device to: receive user input to unmask the at least one preview image frame; update the image set to include the unmasked at least one preview image frame; and output the updated image set.

In some aspects, the techniques described herein relate to a mobile device, wherein the user input includes one or more user gestures imaged by an image sensor.

In some aspects, the techniques described herein relate to a mobile device, wherein processing the preview image data occurs substantially in real-time as the preview image data is acquired.

In some aspects, the techniques described herein relate to a mobile device, wherein the at least one machine-learning model is trained to identify the confidential material by identifying indicators associated with the confidential material that are proximate to sensitive information.

In some aspects, the techniques described herein relate to a mobile device, wherein the at least one processor is configured to cause the mobile device to: output a prompt for user confirmation to mask the at least one preview image frame responsive to detecting confidential material in the at least one preview image frame.

In some aspects, the techniques described herein relate to a method performed by a mobile device, the method including: acquiring preview image data including at least one preview image frame; processing the preview image data using at least one machine-learning model trained to identify confidential material; responsive to detecting confidential material in the at least one preview image frame, masking the at least one preview image frame of the preview image data; generating an image set from the preview image data with the at least one preview image frame masked; and outputting the image set to storage or a display.

In some aspects, the techniques described herein relate to a method, further including: determining a series of preview image frames including the at least one preview image frame and one or more additional preview image frames adjacent to the at least one preview image frame in a sequence of the preview image data; and masking each preview image frame in the series of preview image frames.

In some aspects, the techniques described herein relate to a method, further including: receiving user input to unmask the at least one preview image frame; updating the image set to include the unmasked at least one preview image frame; and outputting the updated image set.

In some aspects, the techniques described herein relate to a system including: at least one memory; and at least one processor coupled with the at least one memory and configured to cause the system to: acquire preview image data including at least one preview image frame; process the preview image data using at least one machine-learning model trained to identify confidential material; responsive to detecting confidential material in the at least one preview image frame, mask the at least one preview image frame of the preview image data; generate an image set from the preview image data with the at least one preview image frame masked; and output the image set to storage or a display.

In some aspects, the techniques described herein relate to a system, wherein the at least one machine-learning model is trained on data describing data entry fields, keypads, personal identification articles, or account identification articles.

In some aspects, the techniques described herein relate to a system, further including an image sensor configured to acquire the preview image data substantially continuously in real-time, and processing the preview image data occurs substantially in real-time as the preview image data is acquired.

What is claimed is:

1. A mobile device comprising:
at least one memory; and
at least one processor coupled with the at least one memory and configured to cause the mobile device to:
acquire preview image data including at least one preview image frame;
process the preview image data using at least one machine-learning model trained to identify confidential material;
responsive to detecting confidential material in the at least one preview image frame, mask the at least one preview image frame of the preview image data;
generate an image set from the preview image data with the at least one preview image frame masked; and
output the image set to storage or a display.

2. The mobile device of claim 1, wherein the at least one machine-learning model is trained on data describing data entry fields, keypads, personal identification articles, or account identification articles.

3. The mobile device of claim 1, wherein the at least one processor is configured to cause the mobile device to:
determine a series of preview image frames including the at least one preview image frame and one or more additional preview image frames adjacent to the at least one preview image frame in a sequence of the preview image data; and
mask each preview image frame in the series of preview image frames.

4. The mobile device of claim 1, wherein the at least one processor is configured to cause the mobile device to:
mask the at least one preview image frame of the preview image data by deleting the at least one preview image frame from the preview image data.

5. The mobile device of claim 1, wherein the at least one machine-learning model includes a region-based convolutional neural network.

6. The mobile device of claim 1, wherein the mobile device is a wearable device including an image sensor configured to acquire the preview image data substantially continuously in real-time while the mobile device is worn.

7. The mobile device of claim 1, wherein the at least one processor is configured to cause the mobile device to:
output an indication that the at least one preview image frame has been masked responsive to masking the at least one preview image frame.

8. The mobile device of claim 7, wherein the indication is a visual indicator or an audio indicator.

9. The mobile device of claim 7, wherein the indication includes vibration of the mobile device by a vibration motor.

10. The mobile device of claim 1, wherein the at least one processor is configured to cause the mobile device to:
receive user input to unmask the at least one preview image frame;
update the image set to include the unmasked at least one preview image frame; and
output the updated image set.

11. The mobile device of claim 10, wherein the user input includes one or more user gestures imaged by an image sensor.

12. The mobile device of claim 1, wherein processing the preview image data occurs substantially in real-time as the preview image data is acquired.

13. The mobile device of claim 1, wherein the at least one machine-learning model is trained to identify the confidential material by identifying indicators associated with the confidential material that are proximate to sensitive information.

14. The mobile device of claim 1, wherein the at least one processor is configured to cause the mobile device to:
output a prompt for user confirmation to mask the at least one preview image frame responsive to detecting confidential material in the at least one preview image frame.

15. A method performed by a mobile device, the method comprising:
acquiring preview image data including at least one preview image frame;
processing the preview image data using at least one machine-learning model trained to identify confidential material;
responsive to detecting confidential material in the at least one preview image frame, masking the at least one preview image frame of the preview image data;
generating an image set from the preview image data with the at least one preview image frame masked; and
outputting the image set to storage or a display.

16. The method of claim 15, further comprising:
determining a series of preview image frames including the at least one preview image frame and one or more additional preview image frames adjacent to the at least one preview image frame in a sequence of the preview image data; and
masking each preview image frame in the series of preview image frames.

17. The method of claim 15, further comprising:
receiving user input to unmask the at least one preview image frame;
updating the image set to include the at least one preview image frame that was unmasked; and
outputting the updated image set.

18. A system comprising:
at least one memory; and
at least one processor coupled with the at least one memory and configured to cause the system to:
acquire preview image data including at least one preview image frame;
process the preview image data using at least one machine-learning model trained to identify confidential material;
responsive to detecting confidential material in the at least one preview image frame, mask the at least one preview image frame of the preview image data;
generate an image set from the preview image data with the at least one preview image frame masked; and
output the image set to storage or a display.

19. The system of claim 18, wherein the at least one machine-learning model is trained on data describing data entry fields, keypads, personal identification articles, or account identification articles.

20. The system of claim 18, further comprising an image sensor configured to acquire the preview image data substantially continuously in real-time, and processing the preview image data occurs substantially in real-time as the preview image data is acquired.
